(19) United States
(12) Patent Application Publication
(10) Pub. No.: US 2004/0148401 A1
(43) Pub. Date: Jul. 29, 2004

(54) Remote maintenance system

(76) Inventor: Shinichi Momonami, Nara-shi (JP)

Correspondence Address: BIRCH STEWART KOLASCH & BIRCH, PO BOX 747, FALLS CHURCH, VA, 22040-0747, US

(21) Appl. No.: 10/743,157

(22) Filed: Dec. 23, 2003

(30) Foreign Application Priority Data
Dec. 25, 2002 (JP) 2002-375344

(51) Int. Cl. G06F 15/16

(52) U.S. Cl. 709/227

(57) ABSTRACT

A user terminal connected to a PSTN sends a remote maintenance contract signal and a connection completion signal that represents the completion of connection between a user-side LAN and a network interface, to the host terminal via the PSTN. When receiving the contract signal and the connection completion signal, the host terminal selects the Internet as a transmission line for sending remote maintenance information of the user terminal, and sends setting information for enabling communication between the user terminal and the host terminal via the Internet, to the user terminal via the PSTN.

### BACKGROUND OF THE INVENTION

1. Field of the Invention

The present invention relates to a remote maintenance system in which a user terminal and a host terminal are connected via a plurality of transmission lines of different communication methods so that the host terminal carries out maintenance of the user terminal.

2. Description of the Related Art

Japanese Unexamined Patent Publication JP-A 7-85343 (1995) discloses a vending machine management system having such a constitution that information that a vending machine is out of order and information that goods are out of stock are automatically collected from every store via public switched telephone networks (abbreviated as PSTN) so that a sales company can cut labor costs and reduce the loss of sale opportunity.

Japanese Unexamined Patent Publication JP-A 10-154971 (1998) discloses a multiplex communication system that executes communication with a plurality of control apparatuses via two transmission lines, having such a constitution that when an abnormality occurs in one of the two transmission lines during communication based on a first communication method, for example, based on a clock synchronization method, the respective control apparatuses can maintain communication by a second communication method that enables communication via one transmission line, for example, by a bit synchronization method, by using only the other of the two transmission lines and altering the communication method.

Japanese Unexamined Patent Publication JP-A 2000-78175 (2000) discloses a duplicate network system in which a plurality of information processing apparatuses are connected to a pair of networks, having such a constitution that information transmission is executed among the respective information processing apparatuses via one of the networks, and in cases where an abnormality is detected during information transmission via the network, information transmission is executed via the other network, a diagnostic text is continuously sent on a specified cycle to the network in which the abnormality is detected, and the network in which the abnormality is detected is recovered to a normal state when a normal response to this diagnostic text is received.

In JP-A 7-85343, the PSTN is used for transmitting data between a sales company and a store. However, since the transmission speed of the PSTN is relatively slow, there is a problem that it takes time to transmit a large amount of data and the efficiency of transmission is low. Therefore, such a vending machine management system is desired that is capable of high-speed transmission of a large amount of data via not only the PSTN but also a local area network (abbreviated as LAN) and the Internet, and capable of data transmission by the use of the PSTN in case trouble occurs in the LAN and the Internet.

In JP-A 10-154971, even when an abnormality occurs in one of the two transmission lines, communication can be executed by the use of the other transmission line, so that it is possible to increase the reliability of the system. However, since a constitution of executing a connection setting by software from one of the plurality of control apparatuses at the time of, for example, adding a transmission line using the Internet as the second transmission line via the LAN is not employed, there is a need to previously connect the two transmission lines by hardware. Accordingly, there is a problem that maintenance of the control apparatus cannot be carried out with ease in a case where an abnormality occurs in the transmission line.

In JP-A 2000-78175, in a case where an abnormality is detected while information transmission is executed via a network, information transmission can be executed via another network other than the network in which the abnormality is detected, and it is possible to automatically recover the network or a communication line at a moment when the abnormality is solved. However, the information processing apparatuses are connected to the pair of networks of the same communication method in advance, and such a constitution is not employed that a network of a different communication method can be added and used. In other words, such a constitution is not employed that in a case where the information processing apparatuses are connected to a transmission line of a communication method using the PSTN, an automatic setting is done so that communication can be executed via a network of a communication method that is different from the PSTN when the completion of connection to the communication line of the transmission method different from the PSTN is notified from the information processing apparatuses.

### SUMMARY OF THE INVENTION

An object of the invention is to provide a remote maintenance system that, in a case where an abnormality occurs in a predetermined first transmission line of a plurality of transmission lines, is capable of automatically setting so as to enable communication between a user terminal and a host terminal via a predetermined second transmission line, and capable of carrying out maintenance with ease and in a short time.

The invention is a remote maintenance system comprising:

a plurality of user terminals that are connected to at least a plurality of transmission lines of different communication methods;

a host terminal that is connected to the plurality of transmission lines so as to manage specified maintenance information of the user terminals that are under specified contracts;

a user-side local area network that is connected to a specified transmission line of the plurality of transmission lines so as to connect the plurality of user terminals; and

a network interface for connecting the plurality of user terminals and the user-side local area network,

wherein when the user terminal connected to a predetermined first transmission line of the plurality of transmission lines sends a specified contract signal and a connection completion signal that represents the completion of connection between the user-side local area network and the network interface, to the host terminal via the first transmission line:

the host terminal selects a predetermined second transmission line from among the plurality of transmission lines as a transmission line for sending data that includes the specified maintenance information, and sends setting information for enabling communication between the user terminal and the host terminal via the second transmission line, to the user terminal via the first transmission line; and

the user terminal receives the setting information sent from the host terminal, and makes a setting so as to enable communication between the user terminal and the host terminal via the second transmission line on the basis of the received setting information.

According to the invention, the user terminal connected to the first transmission line sends a specified contract signal, for example, a remote maintenance contract signal that includes a user ID (identification), a telephone number, a main address of an electronic mail and a URL (uniform resource locator), and a connection completion signal that represents the completion of connection between the user-side local area network and the network interface, to the host terminal via the first transmission line. Here, the user terminal is, for example, a copying machine provided with a communication function, and the host terminal is, for example, a host computer. The host terminal receives the remote maintenance contract signal and the connection completion signal that are sent from the user terminal via the first transmission line. When receiving the contract signal and the connection completion signal, the host terminal selects the second transmission line as a transmission line for sending data that includes specified maintenance information of the user terminal, for example, remote maintenance information such as a user ID, a maintenance point and a maintenance state, and sends setting information for enabling communication between the user terminal and the host terminal via the second transmission line, to the user terminal via the first transmission line. The user terminal receives the setting information sent from the host terminal via the first transmission line, and the user terminal makes a setting so as to enable communication between the user terminal and the host terminal via the second transmission line on the basis of the received setting information.

By sending the setting information for enabling communication between the user terminal and the host terminal via the second transmission line, from the host terminal to the user terminal via the first transmission line as mentioned before, it is possible to automatically make a setting so as to enable communication between the user terminal and the host terminal via the second transmission line. Therefore, even when an abnormality occurs in the first transmission line, communication between the user terminal and the host terminal via the second transmission line can be executed, and maintenance of the user terminal when an abnormality occurs in the first transmission line can be carried out with ease and in a short time.

Further, in the invention it is preferable that the user terminal includes resetting monitoring means that monitors the setting information sent from the host terminal, allows a setting for connecting the user terminal and the host terminal via the second transmission line when communication between the user terminal and the host terminal via the second transmission line is not possible, and forbids a setting for reconnecting the user terminal and the host terminal via the second transmission line when the user terminal and the host terminal are already connected via the second transmission line and communication is possible.

According to the invention, the resetting monitoring means allows a setting for connecting the user terminal and the host terminal via the second transmission line when communication between the user terminal and the host terminal via the second transmission line is impossible. Meanwhile, the resetting monitoring means forbids a setting for reconnecting the user terminal and the host terminal via the second transmission line when the user terminal and the host terminal are already connected via the second transmission line and communication is possible.

Since the resetting monitoring means forbids a setting for reconnecting the user terminal and-the host terminal when the user terminal and the host terminal are already connected via the second transmission line and communication is possible as mentioned above, it is possible to prevent that setting information stored in the user terminal is rewritten by the setting for reconnecting the user terminal and the host terminal Consequently, it is possible to prevent that rewriting of the setting information hinders communication between the user terminal and the host terminal via the second transmission line.

Further, in the invention it is preferable that:

the user terminal further includes user terminal diagnosing means that diagnoses whether the network interface is available or unavailable; and

when the user terminal diagnosing means diagnoses that the network interface is unavailable, information that the network interface is unavailable is sent to the host terminal via the first transmission line.

According to the invention, the user terminal diagnosing means diagnoses whether the network interface is available or unavailable. In a case where the user terminal diagnosing means diagnoses that the network interface is unavailable, and communication between the user terminal and the host terminal via the second transmission line cannot be executed, the user terminal sends information that the network interface is unavailable, to the host terminal via the first transmission line. When receiving the information that the network interface is unavailable, the user terminal executes communication with the host terminal via the first transmission line. Therefore, even when communication between the user terminal and the host terminal via the second transmission line cannot be executed, communication between the user terminal and the host terminal via the first transmission line can be executed. Consequently, it is possible to increase the reliability of the remote maintenance system.

Further, in the invention it is preferable that the user terminal is connected to the second transmission line via the user-side local area network, the user terminal diagnosing means diagnoses whether the user-side local area network has an abnormality, and when the user terminal diagnosing means diagnoses that the user-side local area network has an abnormality, information that the user-side local area network has an abnormality is sent to the host terminal via the first transmission line.

According to the invention, the user terminal diagnosing means diagnoses whether the user-side local area network has an abnormality. In a case where the user terminal diagnosing means diagnoses that the user-side local area network has an abnormality, and communication between the user terminal and the host terminal via the second transmission line cannot be executed, the user terminal sends information that the user-side local area network has an abnormality, to the host terminal via the first transmission line. When receiving the information that the user-side local area network has an abnormality, the user terminal executes communication with the host terminal via the first transmission line. Therefore, even when communication between the user terminal and the host terminal via the second transmission line cannot be executed, communication between the user terminal and the host terminal via the first transmission line can be executed. Consequently, it is possible to increase the reliability of the remote maintenance system. Moreover, even if the user-side local area network has an abnormality, it is possible to execute communication between the user terminal and the host terminal via the first transmission line by sending the information that the user-side local area network has an abnormality, from the user terminal to the host terminal via the first transmission line, so that communication between the user terminal and the host terminal can be continuously executed even when the user terminals are increased.

Further, in the invention it is preferable that:

the host terminal includes host terminal diagnosing means that diagnoses trouble of the user terminal and diagnoses whether communication between the user terminal and the host terminal via the second transmission line is impossible; and

when the host terminal diagnosing means diagnoses that communication between the user terminal and the host terminal via the second transmission line is impossible, the host terminal sends information that communication between the user terminal and the host terminal via the second transmission line is impossible, to the user terminal via the first transmission line, and the user terminal receives the information sent from the host terminal, and causes the user terminal diagnosing means to diagnose whether the network interface is unavailable and whether the user-side local area network has an abnormality.

According to the invention, the host terminal diagnosing means diagnoses trouble of the user terminal, and diagnoses whether communication between the user terminal and the host terminal via the second transmission line is impossible. When the host terminal diagnosing means diagnoses that communication between the user terminal and the host terminal via the second transmission line is impossible, the host terminal sends information that communication between the user terminal and the host terminal via the second transmission line is impossible, to the user terminal via the first transmission line. When the user terminal receives the information sent from the host terminal that communication between the user terminal and the host terminal via the second transmission line is impossible, the user terminal diagnosing means diagnoses whether the network interface is unavailable and whether the user-side local area network has an abnormality.

By merely sending the information that communication between the user terminal and the host terminal via the second transmission line is impossible, from the host terminal to the user terminal via the first transmission line as mentioned above, it is diagnosed by the user terminal diagnosing means whether the network interface is unavailable and whether the user-side local area network has an abnormality. Therefore, maintenance of the user terminal when the network interface is unavailable and when the user-side local area network has an abnormality can be carried out in a short time.

Further, in the invention it is preferable that when receiving at least one of the information that the network interface is unavailable and the information that the user-side local area network has an abnormality, which are sent from the user terminal via the first transmission line, the host terminal sends setting information for enabling communication between the user terminal and the host terminal via the second transmission line, to the user terminal via the first transmission line.

According to the invention, when receiving at least one of the information that the network interface is unavailable and the information that the user-side local area network has an abnormality, which are sent from the user terminal via the first transmission line, the host terminal sends setting information for enabling communication between the user terminal and host terminal via the second transmission line, to the user terminal via the first transmission line. The user terminal receives the setting information sent from the host terminal, and enables communication between the user terminal and the host terminal via the second transmission line on the basis of the setting information at a moment when the network interface becomes available and the user-side local area network is brought into a normal state.

Therefore, in case an abnormality occurs in the first transmission line and communication between the user terminal and host terminal via the first transmission line becomes impossible at the moment when the network interface becomes available and the user-side local area network is brought into a normal state, communication between the user terminal and the host terminal via the second transmission line can be executed because communication between the user terminal and the host terminal via the second transmission line is already in a possible state. Consequently, it is possible to further increase the reliability of the remote maintenance system.

Further, in the invention it is preferable that:

the host terminal further includes data registering means that renews and registers the specified maintenance information of the user terminal that is under the specified contract; and

the user terminal sends the specified maintenance information via a transmission line that is in a communicable state of the first and second transmission lines to the host terminal, and the host terminal receives the maintenance information and then registers the maintenance information into the data registering means.

According to the invention, the user terminal sends the specified maintenance information, for example, remote maintenance information that includes a user ID, a maintenance point and a maintenance state, to the host terminal via a transmission line that is in a communicable state of the first and second transmission lines. The host terminal receives the remote maintenance information sent from the user terminal, and registers the remote maintenance information into the data registering means. Meanwhile, the user terminal that is under the specified contract, for example, a remote maintenance contract with the host terminal can read out desired data from the remote maintenance information that is previously registered in the data registering means, and store into the user terminal.

Further, in the invention it is preferable that the remote maintenance system further comprises a host-side local area network that is connected to a specified transmission line of the plurality of transmission lines so as to connect the host terminal, wherein the host terminal is connected to the second transmission line via the host-side local area network.

According to the invention, the host terminal is connected to the second transmission line via the host-side local area network. Therefore, even when an abnormality occurs in the first transmission line while the user terminal executes communication with the host terminal via the first transmission line, and communication between the user terminal and the host terminal via the first transmission line becomes impossible, communication between the user terminal and the host terminal via the second transmission line can be executed. Consequently, it is possible to further increase the reliability of the remote maintenance system.

Further, in the invention it is preferable that the first transmission line is constituted by a public switched telephone network.

According to the invention, the public switched telephone network is used as the first transmission line in the remote maintenance system. Since the public switched telephone network is already widespread and does not need a special construction on use, it is possible to prevent increase of costs in the remote maintenance system.

Further, in the invention it is preferable that the second transmission line is constituted by a line network that is capable of high-speed transmission of a large amount of data.

According to the invention, a line network that is capable of high-speed transmission of a large amount of data is used as the second transmission line in the remote maintenance system. Since communication between the user terminal and the host terminal via the line network that is capable of high-speed transmission enables high-speed transmission of a large amount of data, it is possible to shorten a time to transmit data compared with communication between the user terminal and the host terminal via the public switched telephone network, and it is possible to carry out maintenance of the user terminal in a short time.

### BRIEF DESCRIPTION OF THE DRAWINGS

Other and further objects, features, and advantages of the invention will be more explicit from the following detailed description taken with reference to the drawings wherein:

FIG. 1 is a view schematically showing the constitution of a remote maintenance system that is an embodiment of the present invention;

FIG. 2 is a block diagram showing the constitution of the remote maintenance system;

FIG. 3 is a flowchart for describing an operation of the remote maintenance system;

FIG. 4 is a flowchart for describing an operation of the remote maintenance system; and

FIG. 5 is a flowchart for describing an operation of the remote maintenance system.

### DETAILED DESCRIPTION OF THE PREFERRED EMBODIMENTS

Now referring to the drawings, preferred embodiments of the invention are described below.

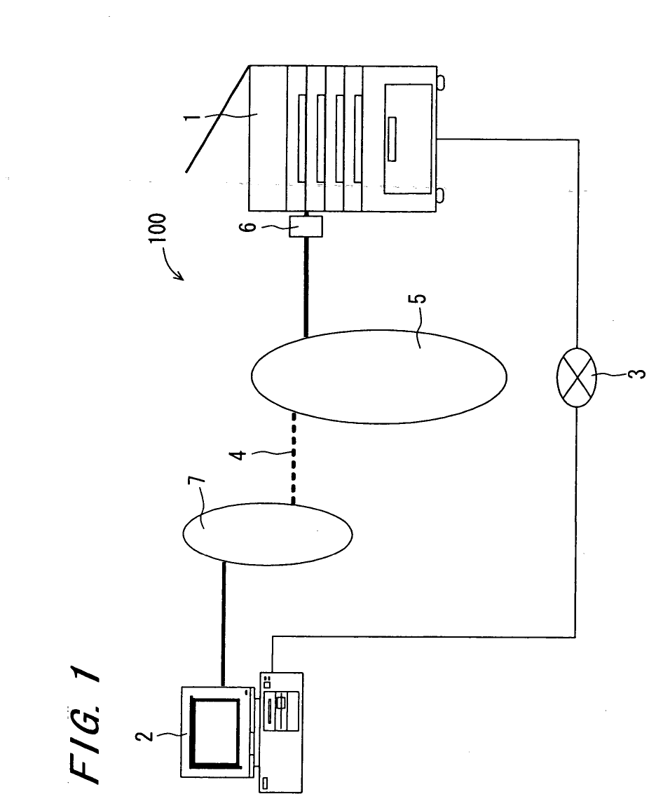

FIG. 1 is a view schematically showing the constitution of a remote maintenance system 100 that is an embodiment of the present invention. As shown in FIG. 1, the remote maintenance system 100 comprises a user terminal 1, a host terminal 2, a first transmission line 3, a second transmission line 4, a user-side LAN (local area network) 5, a network interface 6, and a host-side LAN 7.

The user terminal 1 is realized by, for example, a copying machine, a facsimile apparatus and the like provided with two different communication functions of a communication modem function and a network protocol function, and constituted so as to be connectable to at least the first transmission line 3 and the second transmission line 4 of different communication methods. The communication method of the first transmission line 3 is of, for example, Recommendation T.30 by ITU-T (the International Telecommunication Union-telecommunications standardization sector), and the communication method of the second transmission line 4 is of, for example, TCP-IP (transmission control protocol/Internet protocol).

The host terminal 2 is realized by, for example, a host computer, a personal computer (abbreviated as PC) and the like provided with two different communication functions of a fax modem function and an electronic mail function, and constituted so as to be connectable to the first and second transmission lines 3, 4. Moreover, the host terminal 2 manages remote maintenance information of the user terminal 1 that is under a remote maintenance contract.

Here, the remote maintenance is a remote maintenance operation of fixing and inspecting hardware and software of the user terminal 1 and replacing and adding software, via the first and second transmission lines 3, 4 from the host terminal 2 connected to the user terminal 1. The remote maintenance information is, for example, a time to replace toner and a lack of paper in a case where the user terminal 1 is a copying machine.

The first transmission line 3 is realized by, for example, the public switched telephone network (abbreviated as PSTN) The second transmission line 4 is realized by, for example, the Internet, which is a line network capable of transmission of a large amount of data at a higher speed than the PSTN 3. In a description below, there is a case where the first transmission line is referred to as “the PSTN” and the second transmission is referred to as “the Internet”.

The user-side LAN 5 is a network for connecting a plurality of user terminals 1, and connected to the Internet 4. The network interface 6 is realized by, for example, a network interface card and a LAN adaptor for individually connecting the user terminal 1 to the user-side LAN 5. The host-side LAN 7 is a network for connecting the host terminal 2, and connected to the Internet 4.

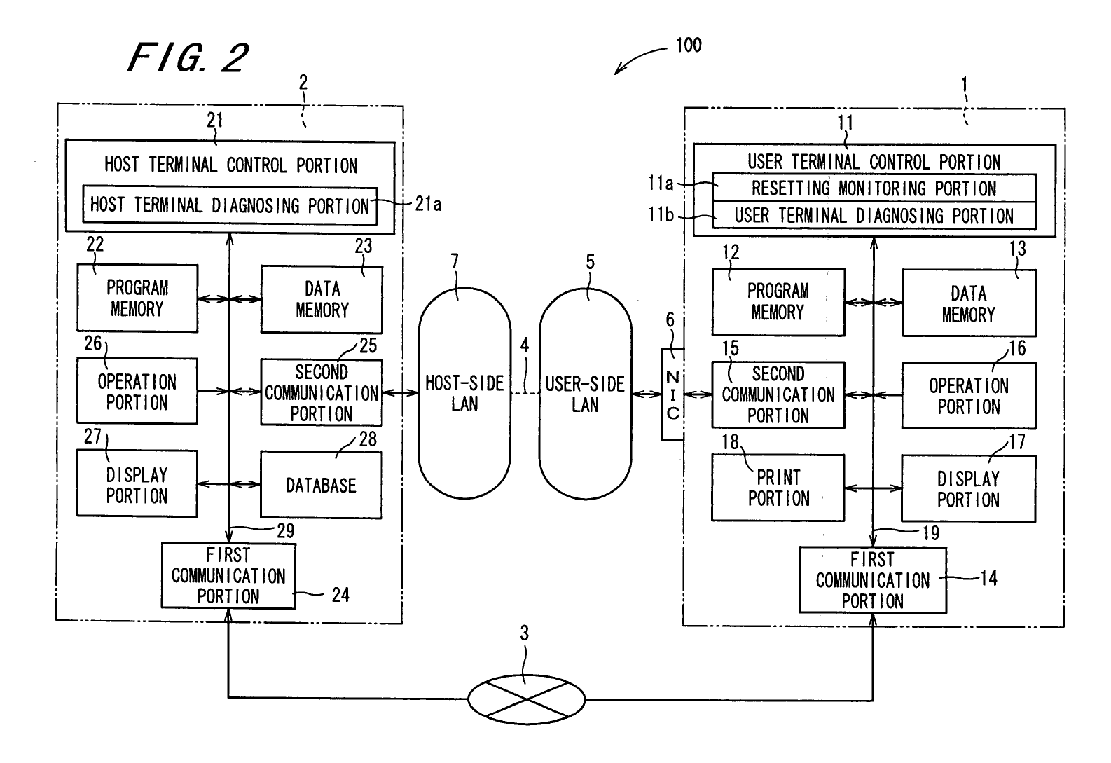

FIG. 2 is a block diagram showing the constitution of the remote maintenance system 100. The remote maintenance system 100 comprises the user terminal 1, the host terminal 2, the first transmission line 3, the second transmission line 4, the user-side LAN 5, the network interface 6, and the host-side LAN 7.

The user terminal 1 includes a user terminal control portion 11, a program memory 12, a data memory 13, a first communication portion 14, a second communication portion 15, an operation portion 16, a display portion 17, a print portion 18, and a bus 19. The user terminal control portion 11 includes a resetting monitoring portion 11a as resetting monitoring means and a user terminal diagnosing portion 11b as user terminal diagnosing means. The user terminal control portion 11 is constituted by, for example, a CPU (central processing unit) and an MPU (micro processing unit), and executes a control program pre-stored in the program memory 12 to execute a function as a copying machine. Moreover, the user terminal control portion 11 controls hardware resources including the aforementioned program memory 12, data memory 13, first communication portion 14, second communication portion 15, operation portion 16, display portion 17, print portion 18 and bus 19 that constitute the user terminal 1.

The resetting monitoring portion 11a monitors setting information such as an IP (Internet protocol) address that is sent from the host terminal 2, and gives the host terminal 2 permission of a setting for connecting to the user terminal 1 when communication via the Internet 4 is impossible. Meanwhile, the resetting monitoring portion 11a forbids a setting for reconnecting to the user terminal 1 via the Internet 4 when the user terminal 1 is already connected to the Internet 4 and communication between the user terminal 1 and the host terminal 2 is possible.

The user terminal diagnosing portion 11b diagnoses whether the network interface 6 is available or unavailable, and diagnoses whether there is an abnormality in the user-side LAN 5. When the user terminal diagnosing portion 11b determines that the network interface 6 is unavailable, information that the network interface 6 is unavailable is sent to the host terminal 2 via the PSTN 3. When the user terminal diagnosing portion 11b determines that there is an abnormality in the user-side LAN 5, information that the user-side LAN 5 has an abnormality is sent to the host terminal 2 via the PSTN 3.

The program memory 12 is realized by, for example, a storage medium such as a ROM (read only memory) and an EEPROM (electronically erasable and programmable read only memory), and pre-stores a control program for control of the hardware resources of the whole user terminal 1 executed by the user terminal control portion 11. The data memory 13 is realized by, for example, a storage medium such as a RAM (random access memory), an EEPROM, a hard disk and a CD-R/RW (compact disk-recordable/rewritable), and temporarily stores input/output data when the user terminal control portion 11 controls the hardware resources of the whole user terminal 1.

The first communication portion 14 is realized by, for example, a modem that is a signal conversion apparatus for executing data communication with the host terminal 2 via a line control circuit for connecting to the PSTN 3 and the PSTM 3. The second communication portion 15 is realized by, for example, a modem that is a signal conversion apparatus for executing data communication with the host terminal 2 via the network interface 6, the user-side LAN 5 and the Internet 4.

The operation portion 16 is constituted by a registration key for registering data that includes, for example, a user ID (identification), a telephone number, a mail address of an electronic mail, a URL (uniform resource locator), a maintenance point and a maintenance state, into the data memory 13, and a setting cancellation key for designating a setting and cancellation of various functions. Registration of data and actuation and suspension of various functions designated by the user are executed by the user terminal control portion 11.

The display portion 17 is realized by, for example, a liquid crystal display (abbreviated as LCD), a plasma display (abbreviated as PD), an electroluminescence display (abbreviated as ELD) and the like, and displays a maintenance state, setting conditions of the first and second transmission lines 3, 4 and execution conditions of various functions of a facsimile apparatus and a copying machine. The print portion 18 is realized by, for example, an inkjet printer, a laser printer and the like for printing an inputted image and data.

The host terminal 2 includes a host terminal control portion 21, a program memory 22, a data memory 23, a first communication portion 24, a second communication portion 25, an operation portion 26, a display portion 27, a database 28, and a bus 29. The host terminal control portion 21 includes a host terminal diagnosing portion 21a as host terminal diagnosing means. The host terminal control portion 21 is constituted by, for example, a CPU and an MPU, and executes a control program that is pre-stored in the program memory 22 to manage remote maintenance information of the user terminal 1 that is under a remote maintenance contract. Moreover, the host terminal control portion 21 executes a function as the host terminal diagnosing portion 21a for diagnosing trouble of the user terminal 1, and controls hardware resources including the aforementioned program memory 22, data memory 23, first communication portion 24, second communication portion 25, operation portion 26, display portion 27, database 28 and bus 29 that constitute the host terminal 2.

The host terminal diagnosing portion 21a diagnoses trouble of the user terminal 1 and whether communication with the user terminal 1 via the Internet 4 is impossible, and sends information that the communication via the Internet 4 is impossible to the user terminal 1 via the PSTN 3 when diagnosing that the communication via the Internet 4 is impossible.

The program memory 22 is realized by, for example, a storage medium such as a ROM and an EEPROM, and pre-stores a control program for control of the hardware resources of the whole host terminal 2 executed by the host terminal control portion 21. The data memory 23 is realized by, for example, a storage medium such as a RAM, an EEPROM, a hard disk and a CD-R/RW, and temporarily stores input/output data when the host terminal control portion 21 controls the hardware resources of the whole host terminal 2.

The first communication portion 24 is realized by, for example, a modem that is a signal conversion apparatus for executing data communication with a line control circuit for connecting to the PSTN 3 and the user terminal 1 via the PSTN 3. The second communication portion 25 is realized by, for example, a modem that is a signal conversion apparatus for executing data communication with the user terminal 1 via the host-side LAN 7 and the Internet 4.

The operation portion 26 is constituted by, for example, a registration key for registering data that includes a user ID, a telephone number, a mail address, an URL, a maintenance point and a maintenance state of the user terminal 1 that is under a remote maintenance contract, into the database 28, and a setting cancellation key for designating a setting and cancellation of various functions of a facsimile apparatus and a copying machine. Registration of data and actuation and suspension of various functions designated by the user are executed by the user terminal control portion 21.

The display portion 27 is realized by, for example, an LCD, a PD, an ELD and the like, and displays a maintenance state, setting conditions of the PSTN 3 and the Internet 4 and execution conditions of various functions of a facsimile apparatus and a copying machine. The database 28 is data registering means that is realized by, for example, a storage medium such as a RAM, an EEPROM, a hard disk and a CD-R/RW. The database 28 initially registers remote maintenance information of the user terminal 1 that is under a remote maintenance contract, and reads out the registered information and sends to the user terminal 1 in response to a request from the user terminal 1.

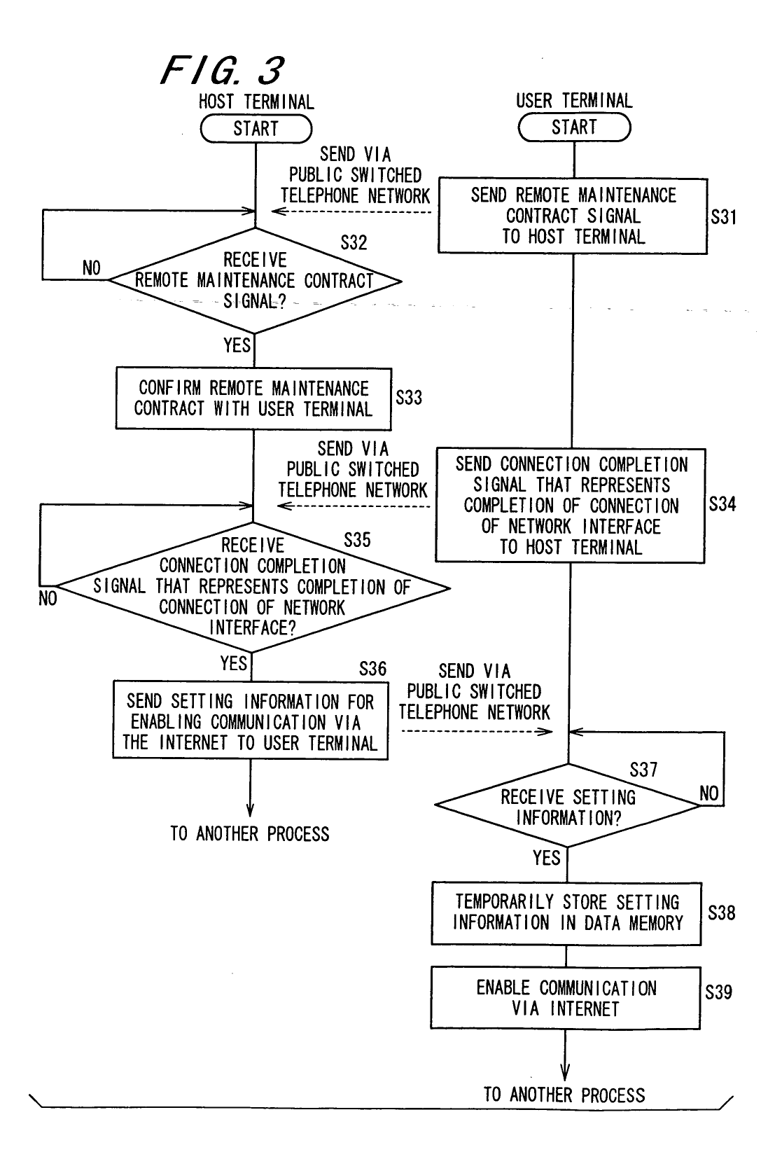

FIG. 3 is a flowchart for describing an operation of the remote maintenance system 100. In FIG. 3, the user terminal 1 and the host terminal 2 are connected via the PSTN 3, and not connected to the Internet 4.

At step S31, the user terminal 1 sends a remote maintenance contract signal that includes a user ID, a telephone number, a mail address of an electronic mail and an URL, to the host terminal 2 via the PSTN 3. At step S32, the host terminal 2 determines whether it has received the remote maintenance contract signal sent from the user terminal 1 via the PSTN 3. In a case where the host terminal 2 determines that it has received the contract signal at step S32, the process proceeds to step S33, and in a case where the host terminal 2 determines that it has not received the contract signal, the process returns to step S32.

At step S33, the host terminal 2 confirms the remote maintenance contract with the user terminal 1 that has sent the remote maintenance contract signal. At step S34, when completing connection of the network interface 6 to the user-side LAN that is previously connected to the Internet 4, the user terminal 1 sends a connection completion signal that represents the completion of connection of the network interface 6 to the user-side LAN 5, to the host terminal 2 via the PSTN 3.

At step S35, the host terminal 2 determines whether it has received the connection completion signal that represents the completion of connection of the network interface 6 to the user-side LAN 5, from the user terminal 1 that is under the remote maintenance contract, via the Internet 4. In a case where the host terminal 2 determines that it has received the connection completion signal at step S35, the process proceeds to step S36, and in a case where the host terminal 2 determines that it has not received the connection completion signal, the process returns to step S35.

At step S36, the host terminal 2 sends setting information for enabling communication with the user terminal 1 via the Internet 4, for example, an IP (Internet protocol) address, to the user terminal 1 via the PSTN 3, and then carries out another process such as a process of monitoring communication from another terminal.

At step S37, the user terminal 1 determines whether it has received the setting information sent from the host terminal 2 via the PSTN 3. In a case where the user terminal 1 determines that it has received the setting information at step S37, the process proceeds to step S38, and in a case where the user terminal 1 determines that it has not received the setting information, the process returns to step S37.

At step S38, the user terminal 1 temporarily stores the received setting information into the data memory 13. At step S39, the user terminal 1 enables communication between the user terminal 1 and the host terminal 2 via the Internet 4 on the basis of the setting information, and then carries out another process such as a process of monitoring the arrival of a facsimile, for example.

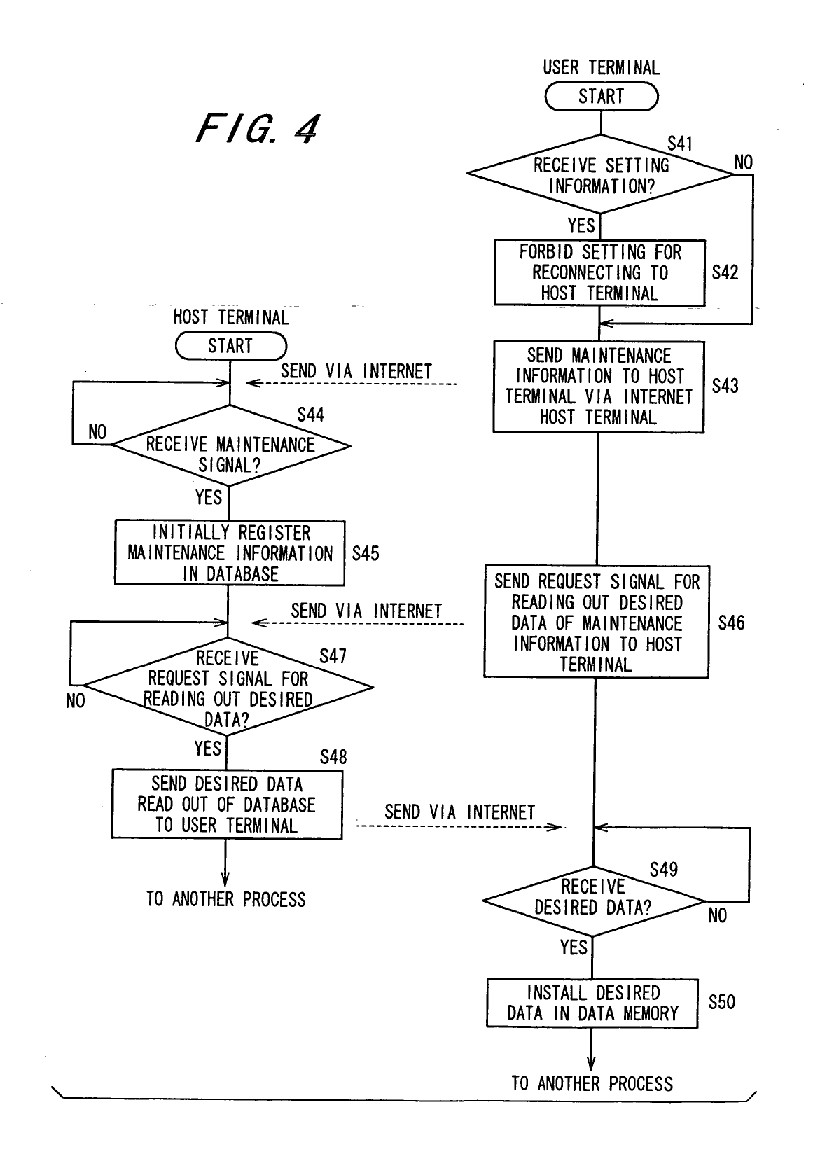

FIG. 4 is a flowchart for describing an operation of the remote maintenance system 100. In FIG. 4, the user terminal 1 and the host terminal 2 are connected to the PSTN 3 and the Internet 4.

At step S41, the user terminal 1 monitors setting information sent from the host terminal 2, and determines whether it has received the setting information sent from the host terminal 2 via the PSTN 3 or the Internet 4. In a case where the user terminal 1 determines that it has received the setting information at step S41, the process proceeds to step S42, and in a case where the user terminal 1 determines that it has not received the setting information, the process proceeds to step S43.

At step S42, in a case where the user terminal 1 and the host terminal 2 are already in a state of being communicable via the Internet 4, the user terminal 1 forbids a setting for reconnecting the user terminal and the host terminal via the Internet 4, and the process proceeds to step S43. At step S43, the user terminal I sends remote maintenance information that includes a user ID, a maintenance point and a maintenance state, to the host terminal 2 via the Internet 4.

At step S44, the host terminal 2 determines whether it has received the remote maintenance information sent from the user terminal 1 via the Internet 4. In a case where the host terminal 2 determines that it has received the remote maintenance information at step S44, the process proceeds to step S45, and in a case where the host terminal 2 determines that it has not received the remote maintenance information, the process returns to step S44.

At step S45, the host terminal 2 initially registers the received remote maintenance information into the database 28. At step S46, the user terminal 1 sends a request signal for reading out desired data from the remote maintenance information initially registered into the database 28, to the host terminal 2 via the Internet 4.

At step 47, the host terminal 2 determines whether it has received the request signal for reading out the desired data sent from the user terminal 1. In a case where the host terminal 2 determines that it has received the request signal for reading out the desired data at step S47, the process proceeds to step S48, and in a case where the host terminal 2 determines that it has not received the request signal for reading out the desired data, the process returns to step S47.

At step S48, the host terminal 2 sends the desired data read out of the database 28, to the user terminal 1 via the Internet 4, and then carries out another process such as a process of monitoring communication from another terminal, for example.

At step S49, the user terminal 1 determines whether it has received the desired data sent from the host terminal 2 via the Internet 4. In a case where the user terminal 1 determines that it has received the desired data sent from the host terminal 2 via the Internet 4 at step S49, the process proceeds to step S50, and in a case where the user terminal 1 determines that it has not received the desired data sent from the host terminal 2 via the Internet 4, the process returns to step S49. At step S50, the user terminal 1 installs the received desired data into the data memory 13, and then carries out another process such as a process of monitoring the arrival of a facsimile, for example.

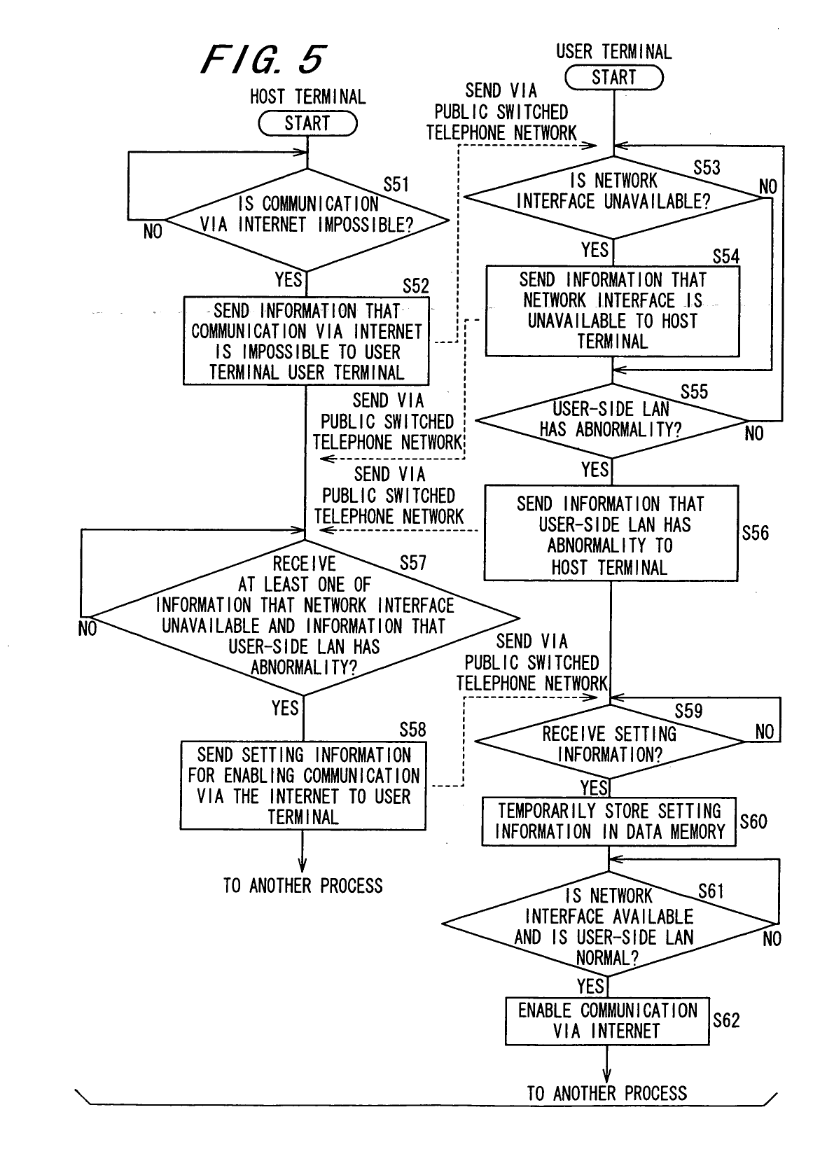

FIG. 5 is a flowchart for describing an operation of the remote maintenance system. In FIG. 5, the user terminal 1 and the host terminal 2 are connected to the PSTN 3 and the Internet 4.

At step S51, the host terminal 2 determines whether communication between the user terminal 1 and the host terminal 2 via the Internet 4 is impossible. In a case where it is determined at step S51 that communication between the user terminal 1 and the host terminal 2 via the Internet 4 is impossible, the process proceeds to step S52, and in a case where it is determined that communication between the user terminal 1 and the host terminal 2 via the Internet 4 is possible, the process returns to step S51.

At step S52, the host terminal 2 sends information that communication between the user terminal 1 and the host terminal 2 via the Internet 4 is impossible, to the user terminal 1 via the PSTN 3. At step S53, the user terminal 1 determines whether the network interface 6 is unavailable. In a case where it is determined at step S53 that the network interface 6 is unavailable, the process proceeds to step S54, and in a case where it is determined that the network interface 6 is available, the process proceeds to step S55.

At step S54, the user terminal 1 sends information that the network interface 6 is unavailable, to the host terminal 2 via the PSTN 3, and the process proceeds to step S57. At step S55, the user terminal 1 determines whether the user-side LAN 5 has an abnormality. In a case where it is determined at step S55 that the user-side LAN 5 has an abnormality, the process proceeds to step S56, and in a case where it is determined that the user-side LAN 5 does not have an abnormality, the process returns to step S53.

At step S56, information that the user-side LAN 5 has an abnormality is sent to the host terminal 2 via the PSTN 3, and the process proceeds to step S57. At step S57, the host terminal 2 determines whether it has received at least one of the information that the network interface 6 is unavailable and the information that the user-side LAN 5 has an abnormality, which are sent from the user terminal 1 via the PSTN 3. In a case where it is determined at step S57 that at least one of the information that the network interface 6 is unavailable and the information that the user-side LAN 5 has an abnormality has been received, the process proceeds to step S58, and in a case where it is determined that either the information that the network interface 6 is unavailable or the information that the user-side LAN 5 has an abnormality has not been received, the process returns to step S57.

At step S58, the host terminal 2 sends setting information for enabling communication between the user terminal 1 and the host terminal 2 via the Internet 4, to the user terminal 1 via the PSTN 3, and then carries out another process such as a process of monitoring communication from another terminal, for example.

At step S59, the user terminal 1 determines whether it has received the setting information sent from the host terminal 2 via the PSTN 3. In a case where the user terminal 1 determines that it has received the setting information sent from the host terminal 2 via the PSTN 3 at step S59, the process proceeds to step S60, and in a case where the user terminal 1 determines that it has not received the setting information sent from the host terminal 2 via the PSTN 3, the process returns to step S59.

At step S60, the user terminal 1 temporarily stores the setting information received from the host terminal 2, into the data memory 13. At step S61, the user terminal 1 determines whether the network interface 6 is available, and determines whether the user-side LAN 5 is in a normal state. In a case where it is determined that the network interface 6 is available and it is determined that the user-side LAN 5 is in a normal state at step S61, the process proceeds to step S62, and in a case where it is determined that the network interface 6 is not available or in a case where it is determined that the user-side LAN 5 is not in a normal state, the process returns to step S61. At step S62, the user terminal 1 enables communication between the user terminal 1 and the host terminal 2 via the Internet 4 on the basis of the setting information temporarily stored into the data memory 13, and then carries out another process such as a process of monitoring the arrival of a facsimile, for example.

As mentioned before, in the remote maintenance system 10, by sending the setting information for enabling communication between the user terminal 1 and the host terminal 2 via the Internet 4, from the host terminal 2 to the user terminal 1 via the PSTN 3, it is possible to automatically set so as to enable communication between the user terminal 1 and the host terminal 2 via the Internet 4. Therefore, even when an abnormality occurs in the PSTN 3, it is possible to execute communication between the user terminal 1 and the host terminal 2 via the Internet 4, and it is possible to carry out maintenance of the user terminal 1 when an abnormality occurs in the PSTN 3 with ease and in a short time.

Further, in the remote maintenance system 100, the resetting monitoring portion 11a of the user terminal control portion 11 forbids a setting for reconnecting the user terminal 1 and the host terminal 2 when the user terminal 1 and the host terminal 2 are already connected via the Internet 4 and communication is possible, so that it is possible to prevent that the setting information stored in the user terminal is rewritten by the setting for reconnecting the user terminal 1 and the host terminal 2. Consequently, it is possible to prevent that rewriting of the setting information hinders communication between the user terminal 1 and the host terminal 2 via the Internet 4.

Further, in a case where the user terminal diagnosing portion 11b in the user terminal control portion 11 diagnoses that the network interface 6 is unavailable and communication between the user terminal 1 and the host terminal 2 via the Internet 4 cannot be executed, the user terminal 1 sends information that the network interface 6 is unavailable, to the host terminal 2 via the PSTN 3. When receiving the information that the network interface 6 is unavailable, the user terminal 1 executes communication with the host terminal 2 via the PSTN 3. Therefore, even when communication between the user terminal 1 and the host terminal 2 via the Internet 4 cannot be executed, communication between the user terminal 1 and the host terminal 2 via the PSTN 3 can be executed. Consequently, it is possible to increase the reliability of the remote maintenance system 100.

Further, in a case where the user terminal diagnosing portion 11b diagnoses that the user-side LAN 5 has an abnormality and communication between the user terminal 1 and the host terminal 2 via the Internet 4 cannot be executed, the user terminal 1 sends information that the user-side LAN 5 has an abnormality, to the host terminal 2 via the PSTN 3. When receiving the information that the user-side LAN 5 has an abnormality, the host terminal 2 executes communication with the host terminal 2 via the PSTN 3. Therefore, even when communication between the user terminal 1 and the host terminal 2 via the Internet 4 cannot be executed, communication between the user terminal 1 and the host terminal 2 via the PSTN 3 can be executed. Consequently, it is possible to increase the reliability of the remote maintenance system 100.

Further, in the remote maintenance system 100, as mentioned before, by merely sending information that communication between the user terminal 1 and the host terminal 2 via the Internet 4 is impossible, from the host terminal 2 to the user terminal 1 via the PSTN 3, it is diagnosed by the user terminal diagnosing portion 11b whether the network interface 6 is unavailable and whether there is an abnormality in the user-side local area network 5. Therefore, it is possible to carry out maintenance of the use terminal 1 in a case where the network interface 6 is unavailable and in a case where the user-side local area network 5 has an abnormality, in a short time.

Further, in the remote maintenance system 100, even when an abnormality occurs in the PSTN 3 and communication between the user terminal 1 and the host terminal 2 via the PSTN 3 becomes impossible at a moment that the network interface 6 becomes available and the user-side LAN 5 is brought into a normal state, communication between the user terminal 1 and the host terminal 2 via the Internet 4 retains a state where communication is possible, so that communication between the user terminal 1 and the host terminal 2 via the Internet 4 can be executed. Consequently, it is possible to further increase the reliability of the remote maintenance system 100.

In the remote maintenance system 100, the user terminal 1 sends data that includes a user ID, a maintenance point and a maintenance state, to the host terminal 2 via a transmission line that is in a communicable state selected from the PSTN 3 and the Internet 4. The host terminal 2 receives the data sent from the user terminal 1, and registers the data into the database 28. Consequently, the user terminal 1 that is under a specified contract such as a remote maintenance contract with the host terminal 2 is allowed to read out desired data from among the data registered in the database 28 to store into the user terminal 1.

Further, in the remote maintenance system 100, the PSTN 3 is used as the first transmission line. Since the PSTN 3 is already widespread and does not need a special construction on using, it is possible to prevent increase of costs in the remote maintenance system 100. Moreover, in the remote maintenance system 100, a line network that is capable of high-speed transmission such as the Internet 4 is used as the second transmission line. Since communication between the user terminal 1 and the host terminal 2 via the Internet 4 enables high-speed transmission of a large amount of data, it is possible to shorten a data transmitting time compared with communication between the user terminal 1 and the host terminal 2 via the PSTN 3, and it is possible to carry out maintenance of the user terminal 1 in a short time.

Although the first transmission line 3 is the PSTN and the second transmission line 4 is the Internet in the above description of the embodiment, other communication lines such as a dedicated line that is a line for data communication between two specific spots, an optic fiber cable line and a CATV (community antenna television) line may be used as the first transmission line 3 and the second transmission line 4 in a remote maintenance system of another embodiment of the invention. Also a remote maintenance system in which these lines are applied to the transmission lines can be embodied in the same manner as the embodiment.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A remote maintenance system comprising:
a plurality of user terminals that are connected to at least a plurality of transmission lines of different communication methods;
a host terminal that is connected to the plurality of transmission lines so as to manage specified maintenance information of the user terminals that are under specified contracts;
a user-side local area network that is connected to a specified transmission line of the plurality of transmission lines so as to connect the plurality of user terminals; and
a network interface for connecting the plurality of user terminals and the user-side local area network,
wherein when the user terminal connected to a predetermined first transmission line of the plurality of transmission lines sends a specified contract signal and a connection completion signal that represents the completion of connection between the user-side local area network and the network interface, to the host terminal via the first transmission line:
the host terminal selects a predetermined second transmission line from among the plurality of transmission lines as a transmission line for sending data that includes the specified maintenance information, and sends setting information for enabling communication between the user terminal and the host terminal via the second transmission line, to the user terminal via the first transmission line; and
the user terminal receives the setting information sent from the host terminal, and makes a setting so as to enable communication-between the user terminal and the host terminal via the second transmission line on the basis of the received setting information.

2. The remote maintenance system of claim 1, wherein the user terminal includes resetting monitoring means that monitors the setting information sent from the host terminal, allows a setting for connecting the user terminal and the host terminal via the second transmission line when communication between the user terminal and the host terminal via the second transmission line is not possible, and forbids a setting for reconnecting the user terminal and the host terminal via the second transmission line when the user terminal and the host terminal are already connected via the second transmission line and communication is possible.

3. The remote maintenance system of claim 1, wherein:
the user terminal further includes user terminal diagnosing means that diagnoses whether the network interface is available or unavailable; and
when the user terminal diagnosing means diagnoses that the network interface is unavailable, information that the network interface is unavailable is sent to the host terminal via the first transmission line.

4. The remote maintenance system of claim 3, wherein the user terminal is connected to the second transmission line via the user-side local area network, the user terminal diagnosing means diagnoses whether the user-side local area network has an abnormality, and when the user terminal diagnosing means diagnoses that the user-side local area network has an abnormality, information that the user-side local area network has an abnormality is sent to the host terminal via the first transmission line.

5. The remote maintenance system of claim 3, wherein:
the host terminal includes host terminal diagnosing means that diagnoses trouble of the user terminal and diagnoses whether communication between the user terminal and the host terminal via the second transmission line is impossible; and
when the host terminal diagnosing means diagnoses that communication between the user terminal and the host terminal via the second transmission line is impossible, the host terminal sends information that communication between the user terminal and the host terminal via the second transmission line is impossible, to the user terminal via the first transmission line, and the user terminal receives the information sent from the host terminal, and causes the user terminal diagnosing means to diagnose whether the network interface is unavailable and whether the user-side local area network has an abnormality.

6. The remote maintenance system of claim 1, wherein when receiving at least one of the information that the network interface is unavailable and the information that the user-side local area network has an abnormality, which are sent from the user terminal via the first transmission line, the host terminal sends setting information for enabling communication between the user terminal and the host terminal via the second transmission line, to the user terminal via the first transmission line.

7. The remote maintenance system of claim 1, wherein:
the host terminal further includes data registering means that renews and registers the specified maintenance information of the user terminal that is under the specified contract; and
the user terminal sends the specified maintenance information via a transmission line that is in a communicable state of the first and second transmission lines to the host terminal, and the host terminal receives the maintenance information and then registers the maintenance information into the data registering means.

8. The remote maintenance system of claim 1, further comprising a host-side local area network that is connected to a specified transmission line of the plurality of transmission lines so as to connect the host terminal,
wherein the host terminal is connected to the second transmission line via the host-side local area network.

9. The remote maintenance system of claim 1, wherein the first transmission line is constituted by a public switched telephone network.

10. The remote maintenance system of claim 1, wherein the second transmission line is constituted by a line network that is capable of high-speed transmission of a large amount of data.
